(19) United States
(12) Patent Application Publication
(10) Pub. No.: US 2009/0176033 A1
(43) Pub. Date: Jul. 9, 2009

(54) Manufacturing Optical Elements With Refractive Functions

(76) Inventors: Juan Maria Gonzalez Leal, Puerto Real (ES); Jose Andres Angel Ruiz, Puerto Real (ES)

Correspondence Address: FISH & RICHARDSON P.C., P.O BOX 1022, Minneapolis, MN, 55440-1022, US

(21) Appl. No.: 12/281,756

(22) PCT Filed: Jan. 31, 2007
(86) PCT No.: PCT/ES2007/000053

§ 371 Date: Jan. 8, 2009

(30) Foreign Application Priority Data
Mar. 9, 2006 (ES) P200600592

(51) Int. Cl. B05D 3/06

(52) U.S. Cl. 427/532

(57) ABSTRACT

A method for the manufacture of refractive optical elements includes (a) placing a substrate close to a starting material, both arranged inside a chamber; (b) vaporizing or subliming the starting material by means of light irradiation; and (c) depositing this vapour phase on the substrate. The coating deposited has a refractive optical functionality on account of its composition and profile and also presents an increase in the threshold of damage at high light intensities.

### CROSS-REFERENCE TO RELATED APPLICATIONS

This application is the national stage of International Application No. PCT/ES2007/000053, filed Jan. 31, 2007, which claims priority under 35 U.S.C. §119(a) to Spanish Application No. P200600592 filed Mar. 9, 2006.

### FIELD OF THE INVENTION

The present invention lies within the field of optical elements with refractive functions, and methods of manufacturing them.

Optics elements are very important in all technological fields where it is necessary to modulate the spatial distribution of light. Bearing in mind this requirement, it is necessary to optimise techniques of manufacturing simple optical structures and producing optical structures with new functions.

Most of the methods used to manufacture refractive optical elements on a medium-sized scale use repeated cutting and polishing processes, or heated moulding processes, prior to more complex subsequent treatments. Alternatively, different processes have been developed to manufacture elements on a small scale, based on complex multiple surface micromachining, or photolithography steps, and more recent methods that propose the ablation of plastic or glass surfaces, or the heat-assisted structural modification of semiconductor doped glass surfaces using lasers. Furthermore, methods of light-assisted deposits are used in planar technology production processes, the aim of which is to create a uniform layer of conductor, semiconductor or superconductor compounds on a substrate to form active and passive optical devices and/or planar electronic devices.

### SUMMARY OF THE INVENTION

We present a simple, although not obvious, method for the light-assisted manufacturing of optical elements, various examples of which can take advantage of the following process considerations:

1. Structural fragments of the constituent elements of semiconductor compounds can be ejected from a solid when they are irradiated with light whose photon energy is comparable (in the order of magnitude) to its optical gap, with a high enough intensity. This intensify depends on the type of semiconductor material.

2. The vapour phase, or plasma plume, that is generated condenses on a substrate located in the proximity of the starting material, causing this material to be deposited on die substrate.

3. The morphology of the deposit is related to the characteristics of the plume or vapour phase, which depend on the spatial light intensity distribution on the target material, the spectral radiance of the light source, the distance between the target material and the substrate, the pressure and the atmosphere in the chamber, the temperature of the starting material, the temperature of the substrate, and the irradiation time.

4. Concurrent illumination of the deposit during its growth may affect the physicochemical properties of the material that forms said deposit, as a consequence of its effect on the structure being formed.

In a preferred embodiment of the invention, which is not limiting in terms of the material used or the configuration of the manufacturing system, a continuous laser beam, with a wavelength of 532 nm and a Gaussian light intensity distribution, perpendicularly crosses a transparent substrate with planoparallel sides before reaching a target material situated a few millimetres from the substrate. Said target material is a disc (wafer) with a diameter of around 1 cm and a thickness of 2 mm, made from compacted powder of an amorphous V-VI semiconductor alloy (e.g. an alloy of As and S), which is sensitive to the photon energy of light radiation from a Nd:YAG laser (2.33 eV). The sides of the substrate and the wafer that face each other are parallel.

The above-described configuration produces a deposit with an aspheric profile that generates an optical function as shown in FIG. 1, which is characteristic of optical elements called axicons. Axicons, as shown in FIG. 2, unlike lenses with conventional spherical profiles, are characterised in that they concentrate light energy along a focal segment that extends along the optical axis, and their lateral resolution remains constant to propagation on this focal segment.

The transparency of V-VI semiconductors in the infrared (IR) spectral region guarantees the stability of the optical elements manufactured in this spectral window, therefore making it the preferred working spectral region.

However, we have observed that the optical elements produced according to the above-described preferred embodiment present a greater optical transparency and a higher damage threshold to the laser radiation used in the manufacturing process compared to that of the starting material, possibly due to concurrent uniform illumination of the material being deposited. In experiments, an increase of more than one order of magnitude has been observed in the damage intensity in alloys with a composition of As₂₀S₈₀, in relation to the intensity supported by the starting material.

Furthermore, it has been shown that coating an amorphous chalcogenide deposit with a layer of polymethyl methacrylate (PMMA) increases by several orders of magnitude the damage threshold to radiation for which the chalcogenide alloy would be sensitive without any coating.

In view of such findings, both of our own and as reported in the literature, it can be inferred that although the IR region is the preferred window, it should not be considered the only one.

The present invention discloses a simple method of manufacturing refractive optical elements, which is based on the light-assisted control of the profile of a semiconductor material that will be deposited on a substrate that is transparent to the working radiation, for which the optical element to be manufactured is designed. The method makes it possible to extend the functions of the optical elements that are manufactured so that they may be used at high light intensities.

### BRIEF DESCRIPTION OF THE FIGURES

FIG. 1 illustrates light intensity distribution along the focal axis corresponding to an axicon, using an amorphous alloy with a composition of As₂₀S₈₀. The distances are measured in relation to the position of the axicon. A lateral resolution of about 60 μm is achieved at a distance of 35 mm from the axicon, and is maintained up to 45 mm, the position from which the energy begins to couple to higher modes than the zero order mode. The wavelength of the laser radiation used in these measurements was 532 mm.

FIG. 2 is a diagram showing how an extended focal lens (axicon) works. This aspheric optical element presents a focal region on the optical axis with a high lateral resolution (of the order of microns) and a long depth of focus, Δf, from an initial focusing distance f₀. The light intensity distribution at different distances along the optical axis is also shown.

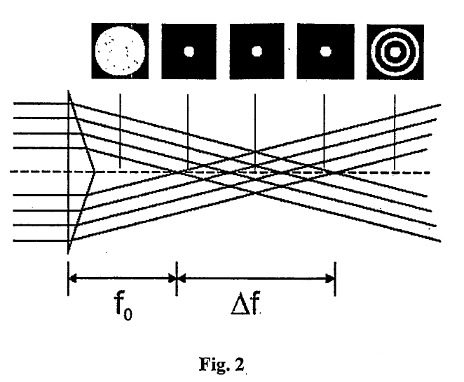

FIG. 3 is a cross-sectional diagram of a system for producing refractive optical elements, in a baste configuration wherein a light beam falls on the starting material at normal incidence, after crossing a transparent substrate.

FIG. 4 is a cross-sectional diagram of a system for producing refractive optical elements. In a basic configuration wherein two light beams fall on the starting material, one with normal incidence to the starting material, which crosses the substrate, and a second light beam that falls obliquely on the material without crossing the substrate.

### DETAILED DESCRIPTION

The following describes examples of methods for manufacturing refractive optical elements in a simple and economical way. The examples generally include the following steps: (a) situating a substrate close to a target material, both of which are situated inside a chamber, (b) using a light source to bring about the vaporisation or sublimation of the target material and (c) depositing this vapour phase on the substrate. The manufactured optical element presents a refractive optical function due to its composition and profile, as well as an increase in the damage threshold at high light intensities.

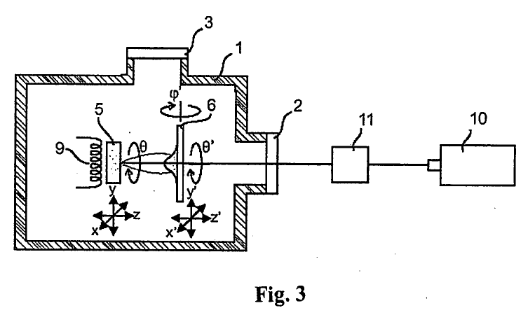

FIG. 3 shows one example of a method for manufacturing optical elements with a refractive function. With reference to this figure, the system features a chamber 1 with transparent windows 2 and 3, and a source of continuous or pulsed light radiation 10, a starting material 5, and a substrate 6 which is transparent to the radiation from light source 10, and also transparent to the working radiation for which the optical element to be manufactured is designed. The light beam from source 10 enters the chamber through a transparent window 2, and crosses the substrate 6 before tailing on the starting material 5, causing its ejection. The generation of this plume can be assisted by heat from a heat source 9. The deposition can also be thermally assisted by supplying heal to the substrate, in a similar way to heat source 9 (not shown in FIG. 3). The spatial intensity distribution on the starting material is controlled by a combination of optical (lenses, mirrors, filters, masks, spatial light, phase and amplitude modulators, etc.) and/or mechanical (linear positioning stages, angular positioning stages, mechanical spatial light modulators, etc.) elements 11. The deposition is carried out at a controlled pressure and atmosphere.

The starting material 5, which is situated inside the chamber, can be an ingot of a semiconductor alloy, or a wafer made from the alloy to be deposited in powder form. The wafer can be a homogeneous or heterogeneous mixture of semiconductor alloys containing a chalcogen element (O, S, Se and/or Te) and other reactants (such as Ge, Ga, Si, P, As, Sb, I, Pm, Sm, Eu, Er, etc.), which act as both passive and active elements for a determined light radiation. Starting material 5 is an amorphous alloy with a composition of As₂₀S₈₀. This starting material is supported by a support system having a combination of mechanical elements that give the starting material freedom to move in the three Cartesian directions, x, y, z, and to rotate around an axis that is perpendicular to its surface, θ.

The substrate 6 is also supported by a combination of mechanical elements in a manner that allows the substrate to move in the three Cartesian directions, x′, y′, z′, as well as to rotate around an axis that is perpendicular to its surface, θ′, and around an axis that is parallel to its surface, φ′, in a way that is not integral to the starting material.

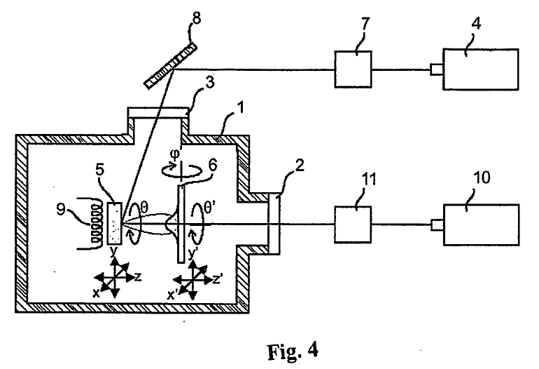

FIG. 4 shows another example of a method for manufacturing optical elements with a retractive function. With reference to this figure, and similarly to that described for FIG. 3, the system consists of a chamber 1 with transparent windows 2 and 3, two sources of continuous or pulsed light radiation 4 and 10, a starting material 5, and a substrate 6 which is transparent to the radiation from light source 10, and also transparent to the working radiation for which the optical element to be manufactured is designed. The spatial intensity distribution, on the starting material is controlled by opto-mechanical control systems 7, 11, each of which includes a combination of optical (lenses, mirrors, filters, masks, spatial light, phase and amplitude modulators, etc.) and/or mechanical (linear positioning stages, angular positioning stages, mechanical spatial light modulators, etc) elements. The light beam from first light source 4 enters the chamber through window 3, after falling on mirror 8. The mirror 8 is mounted on translational and rotary positioning stages that give it degrees of freedom to control, in combination with control, system 7, the light intensity distribution on the starting material. The light beam from second light source 10 enters the chamber through window 2, and crosses the substrate 6 before falling on the starting material 5. The beam from first light source 4 and the beam from second light source 10 do not necessarily fall on the same area of the starting material. The generation of the plume can be assisted by heat from a heat source 9. The deposition can also be thermally assisted by supplying heat to the substrate, in a similar way to beat source 9 (not shown in FIG. 4). The deposition is carried out at a controlled pressure and atmosphere.

The systems shown in FIGS. 3 and 4 involve the uniform illumination of the deposit during its growth. This concurrent uniform irradiation may modify the properties of the material being deposited, depending on its nature and the characteristics of the light radiation that falls on it. This may produce, for instance, a more stable material with a higher damage threshold, and it may therefore extend its functions at high light intensities, as has been described above on the basis of experimental results.

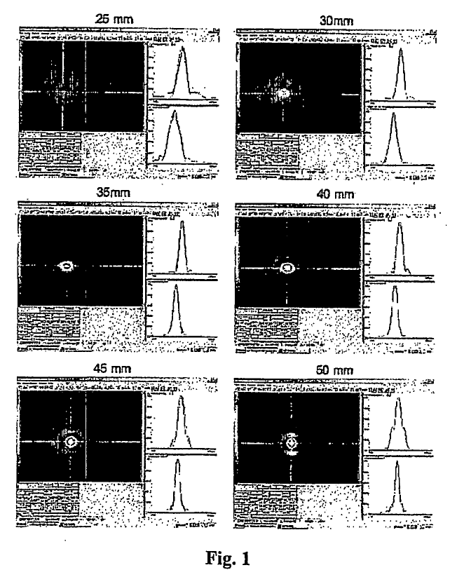

A real embodiment is described below to illustrate the use of the present invention for manufacturing a refractive axicon that is stable and highly transparent in the IR region. The starting material, in this case, is a circular wafer with a 13 mm diameter, made from 125 mg of powder, compacted for 10 minutes with a 10-ton load, of an amorphous chalcogenide alloy with a composition of As₂₀S₈₀, which presents an optical gap of 2.1 eV. The pressure in the chamber is reduced to below 10⁻⁴ mbar. The light radiation comes from a Nd:YAG continuous laser generator emitting at 532 nm (2.33 eV), with a power of 400 mW. The laser beam Induces the ejection of the starting material by ablating the surface of the wafer, generating a distribution of the vapour phase in the form of a spindle (plume), which is perpendicular to the irradiated surface of the wafer. The transparent substrate is situated inside the chamber, in the path of the light beam, at 2 mm from the starting material, so that the beam crosses both sides of the substrate before falling on the starting material. The vapour phase of the starting material condenses on the side of the substrate that faces this material, presenting an aspheric spatial distribution on its surface, which has an optical function as shown in FIG. 1.

The conditions of the system may be adjusted to deposit a uniform profile or a profile of a variable thickness, concentrated on a localised region of the substrate or extended across it according to any other desired distribution. The area covered by the deposit and the thickness profiles may be controlled by moving the light beam over the surface of the starting material and/or the substrate by means of the positioning stages that give the starting material and the substrate the degrees of freedom x, y, z, θ, x′, y′, z′, θ′, φ′, respectively, which are shown in the diagrams in FIGS. 3 and 4.

1-19. (canceled)

20. A method of manufacturing refractive optical elements, the method comprising: positioning a substrate, which is transparent to both a working radiation to which the
optical element to be manufactured is designed and a radiation to he employed in the method, close to a starting material inside a chamber;
irradiating the substrate with light radiation that passes through the substrate;
exposing the starting material to the radiation transmitted through the substrate, in a manner that creates a vapour phase of the starting material;
depositing the vapour phase of the starting material onto the substrate while concurrently and uniformly irradiating the deposited starting material through the substrate during deposition to form a refractive optical element.

21. The method of claim 20, wherein the light radiation is either continuous or pulsed.

22. The method of claim 20, wherein the light radiation is either monochromatic or polychromatic.

23. The method of claim 20, wherein the light radiation is either coherent or incoherent.

24. The method of claim 20, wherein die starting material comprises an ingot or wafer made from pressed powder of material to be deposited.

25. The method of claim 20, wherein the starting material comprises a homogeneous or heterogeneous mixture of semiconductor alloys containing a chalcogen element and other reactants that act as both passive and active elements with respect to a predetermined light radiation.

26. The method of claim 20, wherein the deposition is carried out with a controlled pressure and atmosphere.

27. The method of claim 20, wherein exposing the starting material to the modulated radiation creates a vapour phase of the starting material by combined heating and light radiation.

28. The method of claim 20, wherein irradiation of the substrate is performed while the substrate is at a temperature other than room temperature.

29. The method of claim 20, wherein the refractive optical element presents an optical function corresponding to an axicon-type aspheric lens.

30. The method of claim 20, wherein facing sides of the starting material and the substrate are parallel while the vapour phase of the starting material is deposited.
